(19) United States
(12) Patent Application Publication
(10) Pub. No.: US 2013/0241286 A1
(43) Pub. Date: Sep. 19, 2013

(54) POWER SUPPLY SYSTEM

(71) Applicant: SEMICONDUCTOR ENERGY LABORATORY CO., LTD., Atsugi-shi (JP)

(72) Inventor: Shunpei YAMAZAKI, Setagaya (JP)

(73) Assignee: SEMICONDUCTOR ENERGY LABORATORY CO., LTD., Atsugi-shi (JP)

(21) Appl. No.: 13/789,714

(22) Filed: Mar. 8, 2013

(30) Foreign Application Priority Data
Mar. 14, 2012 (JP) 2012-056842

(51) Int. Cl. H02J 4/00

(52) U.S. Cl. CPC H02J 4/00
USPC 307/38

(57) ABSTRACT

A power supply system which consumes less power by reducing leak current that flows through a switch is provided. The power supply system includes a command unit and a plurality of components each including a power supply line, a load, and a switch which switches electrical connection between the power supply line and the load. The command unit separately controls on/off of the switches, and the switches are transistors including a semiconductor having a wider band gap than silicon in channel formation regions.

### BACKGROUND OF THE INVENTION

1. Field of the Invention

The present invention relates to a power supply system which supplies power to a plurality of components each including a load.

2. Description of the Related Art

For example, a power supply system which supplies power to a load is configured to control power supply from a power supply source such as a commercial power source or a battery to the load by controlling a switch that is connected to the power supply source (e.g., see Patent Document 1).

### REFERENCE

### Patent Document

[Patent Document 1] Japanese Published Patent Application No. 2010-206914

### SUMMARY OF THE INVENTION

In the case of supplying power to a load which needs high power, a power MOSFET or an IGBT (Insulated Gate Bipolar Transistor) is generally used as the switch with which power supply from the power supply source to the load is controlled. Further, in the case of supplying power to a load such as an electronic circuit, a thin film transistor is generally used as the switch. The power MOSFET, the IGBT, and the thin film transistor are each formed using a material including silicon.

A switch formed using a material including silicon has a problem in standby electricity at the time when the load does not use power. This standby electricity is due to leak current flowing through the switch at the time when the load does not use power, and an increase in standby electricity leads to an increase in power consumption. Accordingly, in order to reduce power consumption, it is necessary to reduce leak current flowing through the switch.

Thus, leak current flows through a conventional switch at the standby mode, which makes it difficult to achieve a substantially normally off state.

In view of the technical background as described above, an object of the present invention is to provide a power supply system which consumes less power by reducing leak current that flows through a switch.

A power supply system of one embodiment of the present invention includes a command unit; and a plurality of components each including a power supply line, a load, and a switch which switches electrical connection between the power supply line and the load. The command unit separately controls on/off of the switches. The switch is a transistor including a semiconductor having a wider band gap than silicon in a channel formation region.

Further, a power supply system of one embodiment of the present invention includes a first command unit; second command units; and a plurality of components each including a power supply line, a load, and a switch which switches electrical connection between the power supply line and the load. The first command unit separately controls the second command units. The second command units separately control on/off of the switches. The switch is a transistor including a semiconductor having a wider band gap than silicon in a channel formation region.

Further, a power supply system of one embodiment of the present invention includes a command unit; an L (L is a natural number of 2 or more) number of first components each including a first power supply line, a first load, and a first switch which switches electrical connection between the first power supply line and the first load; an M (M is a natural number of 1 or more) number of second components each including a second power supply line diverged from the first power supply line included in any one of the L number of first components, a second load, and a second switch which switches electrical connection between the second power supply line and the second load; and an N (N is a natural number of 1 or more) number of third components each including a third power supply line diverged from the second power supply line included in any one of the M number of second components, a third load, and a third switch which switches electrical connection between the third power supply line and the third load. The command unit separately controls on/off of the first switch, the second switch, and the third switch. The first switch, the second switch, and the third switch are transistors including a semiconductor having a wider band gap than silicon in channel formation regions.

With one embodiment of the present invention, leak current flowing through the switch can be reduced and thereby power consumption of the power supply system can be reduced.

Further, the switch in one embodiment of the present invention can create a substantially completely off state with no leak current flowing through the switch at the standby mode. Accordingly, the power supply system of one embodiment of the present invention is a substantially normally off system into which a switch that can create a completely off state is introduced for the first time.

### BRIEF DESCRIPTION OF THE DRAWINGS

In the accompanying drawings:

FIG. 1 illustrates a configuration of a power supply system of one embodiment of the present invention;

FIG. 2 illustrates a configuration of a power supply system of one embodiment of the present invention;

FIG. 3 illustrates a configuration of a power supply system of one embodiment of the present invention;

FIG. 4 illustrates a configuration of a power supply system of one embodiment of the present invention;

FIG. 5 illustrates operation of a power supply system of one embodiment of the present invention;

FIG. 6 illustrates operation of a power supply system of one embodiment of the present invention;

FIG. 7 illustrates operation of a power supply system of one embodiment of the present invention;

FIG. 8 illustrates a structure of a transistor;

FIG. 9 illustrates a configuration of a power supply system of one embodiment of the present invention; and

FIG. 10 illustrates a configuration of a power supply system of one embodiment of the present invention.

### DETAILED DESCRIPTION OF THE INVENTION

Embodiments of the present invention are described below in detail with reference to the accompanying drawings. However, the present invention is not limited to the following description and it is easily understood by those skilled in the art that the mode and details can be variously changed without departing from the scope and spirit of the present invention. Accordingly, the present invention should not be construed as being limited to the description of the embodiments below.

### <Configuration of Power Supply System (1)>

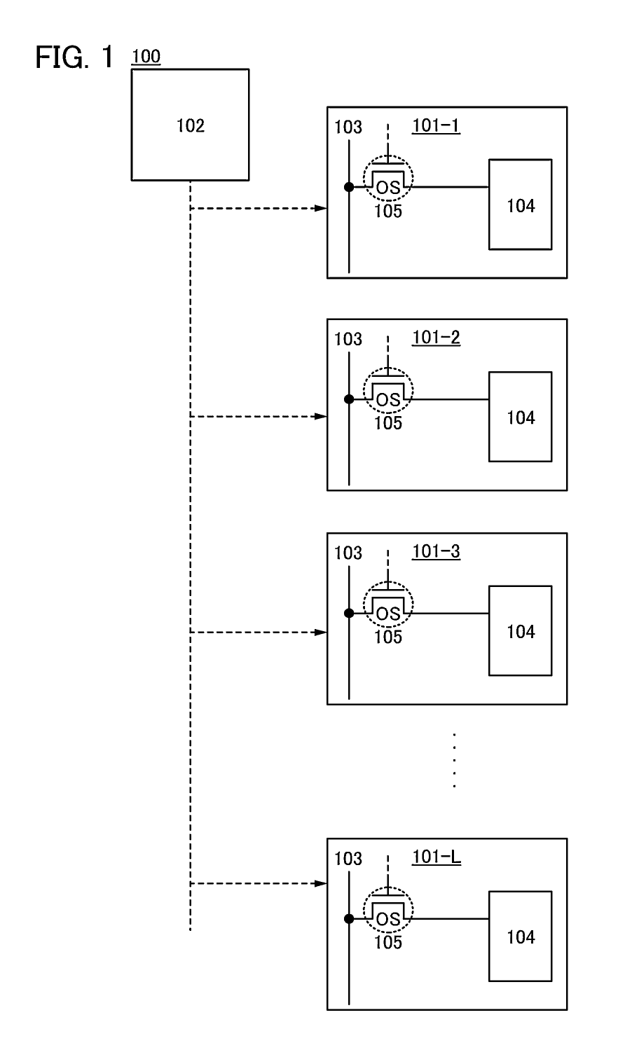

FIG. 1 illustrates an example of the configuration of a power supply system of one embodiment of the present invention. A power supply system 100 illustrated in FIG. 1 includes components 101-1 to 101-L (L is a natural number of 2 or more) and a command unit 102 which separately controls power supply to the components 101-1 to 101-L.

Each of the components 101-1 to 101-L includes a power supply line 103, a load 104 which consumes power, and a switch 105 which switches electrical connection between the power supply line 103 and the load 104. When the switch 105 is on (in a conducting state), power is supplied from the power supply line 103 to the load 104 through the switch 105. When the switch 105 is off (in a non-conducting state), power supply from the power supply line 103 to the load 104 is stopped.

Note that the components 101-1 to 101-L may share the power supply line 103. Alternatively, the power supply line 103 included in at least one component among the components 101-1 to 101-L may be different from the power supply line 103 included in the other components.

In one embodiment of the present invention, as the switch 105, a transistor including in its channel formation region a semiconductor that has a wider band gap than silicon and is highly purified by reducing impurities such as moisture and hydrogen, which serve as electron donors (donors), and oxygen vacancies can be used. The transistor has a significantly low off-state current compared with a transistor including silicon in its channel formation region. Accordingly, with one embodiment of the present invention where a transistor including a semiconductor having a wider band gap than silicon in its channel formation region is used as the switch 105, power supply from the power supply line 103 to the load 104 due to leak current flowing through the switch 105 when the switch 105 is off can be prevented.

Further in one embodiment of the present invention, due to the significantly low off-state current that flows through the switch 105, charge accumulated on the load 104 side can be held in a parasitic capacitor of the load 104. This enables rapid return operation when restarting power supply by turning on the switch.

Note that FIG. 1 illustrates an example in which the switch 105 is one transistor; however, the present invention is not limited to this configuration. In one embodiment of the present invention, the switch 105 may be a plurality of transistors.

The command unit 102 has a function of separately controlling on/off of the switch 105 included in each of the components 101-1 to 101-L. The on/off selection of the switch 105 in each of the components 101-1 to 101-L can be conducted at a command input to the command unit 102 from the outside of the power supply system 100.

Note that in the case where the load included in one component and the load included in another component operate by interacting with each other, such a configuration as to conduct on/off control of the switches 105 all at once by the command unit 102 may be employed. Thus, the power supply system of this embodiment can be driven in such a manner that power is supplied to components necessary for achieving certain purposes for periods necessary for the respective operations and the components operate at the same time or in order in synchronization with each other.

Alternatively, the power supply system 100 may include an ammeter for monitoring the power consumption in the load 104 or the like so that the command unit 102 can judge the necessity of power supply to the load 104 based on the amount of power in the load 104. For example, in the case where the power consumption in the load 104 is approximately the same as the leak power consumed by the load 104 in the standby mode over a certain period, the command unit 102 can judge that the power supply to the load 104 is unnecessary.

Alternatively, the power supply system 100 may include a sensor circuit so that the usage environment and/or the ambient environment of the load 104 can be monitored using physical values of light, sound, temperature, magnetism, pressure, or the like detected by the sensor circuit, and the command unit 102 can judge the necessity of power supply to the load 104 based on a change detected by the monitoring. In this case, the command unit 102 selects on or off of the switch 105 based on results of the judgment on the necessity of power supply.

For example, the power supply system 100 of one embodiment of the present invention is attached to a house. Here, household electrical appliances provided in the house such as a lighting device, an electric heater, and an air cleaner correspond to the components. In this case, using a sensor circuit having an optical sensor, the brightness of the room where the lighting device is used is monitored. When the room becomes brighter than a prescribed value by a change in the amount of light streaming through the window, the command unit 102 can turn off the switch 105 of the lighting device to stop power supply to the lighting device.

Further, using a sensor circuit having a temperature sensor, specifically, the temperature of the room where the electric heater is used is monitored. When the temperature of the room becomes higher than a prescribed value by a change in the outside air temperature, the command unit 102 can turn off the switch 105 of the electric heater to stop power supply to the electric heater.

Further, using a sensor circuit having an optical sensor, the usage status of the room where the air cleaner is used is monitored. When human motion is not detected for a certain period by the sensor circuit, the command unit 102 can turn off the switch 105 of the air cleaner to stop power supply to the air cleaner.

Note that in the case where the above-described household electrical appliances correspond to the components, the switches 105 are incorporated in the respective household electrical appliances. In the case where the switches 105 are provided outside the household electrical appliances, the household electrical appliances correspond to the loads 104, and the components each include the switch 105 and the household electrical appliance corresponding to the load 104.

In the case where the components are provided independently, on/off selection of the switches 105 by the command unit 102 is conducted using wireless signals. In this case, the switches 105 preferably have a structure for holding a signal for changing the switch state from the command unit 102.

The sensor circuit includes the sensor and a circuit group for processing sensor signals output from the sensor. A temperature sensor, a magnetic sensor, an optical sensor, a microphone, a strain gauge, a pressure sensor, a gas sensor, or the like can be used as the sensor. The temperature sensor may be a contact sensor such as a resistance temperature detector, a thermistor, a thermocouple, or an IC temperature sensor, or a non-contact sensor such as a thermal type infrared ray sensor or a quantum type infrared ray sensor.

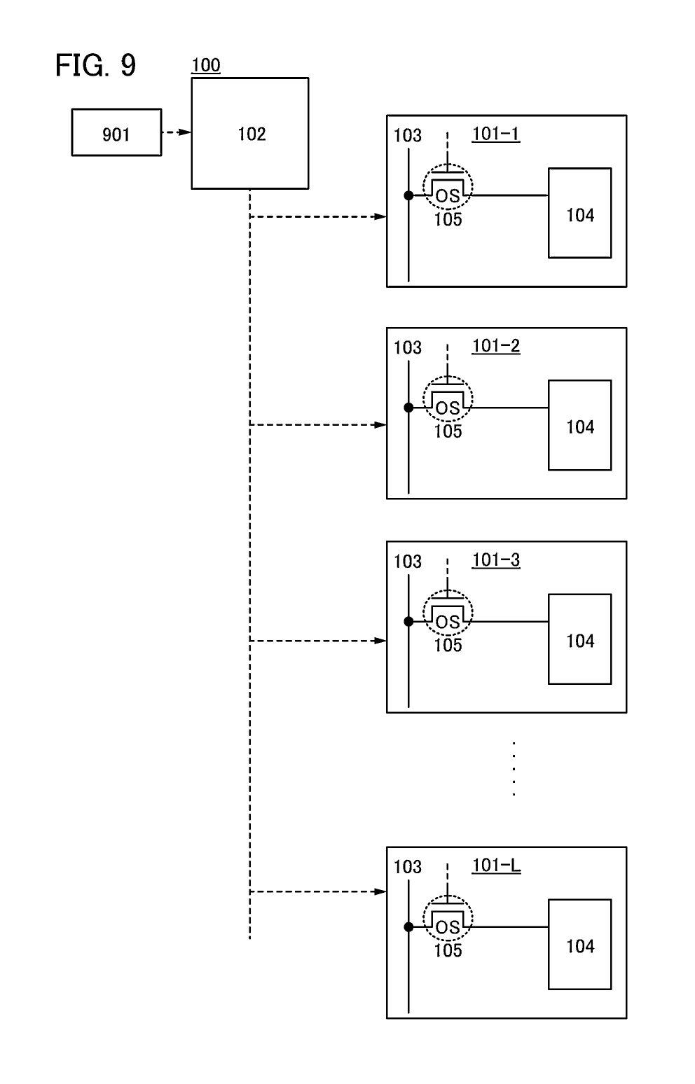

A block diagram of the power supply system 100 illustrated in FIG. 1 including a sensor circuit is illustrated in FIG. 9. As illustrated in FIG. 9, a sensor circuit 901 transmits data concerning physical values to the command unit 102. The command unit 102 monitors the physical values detected by the sensor circuit 901 and judges the necessity of power supply to the loads 104.

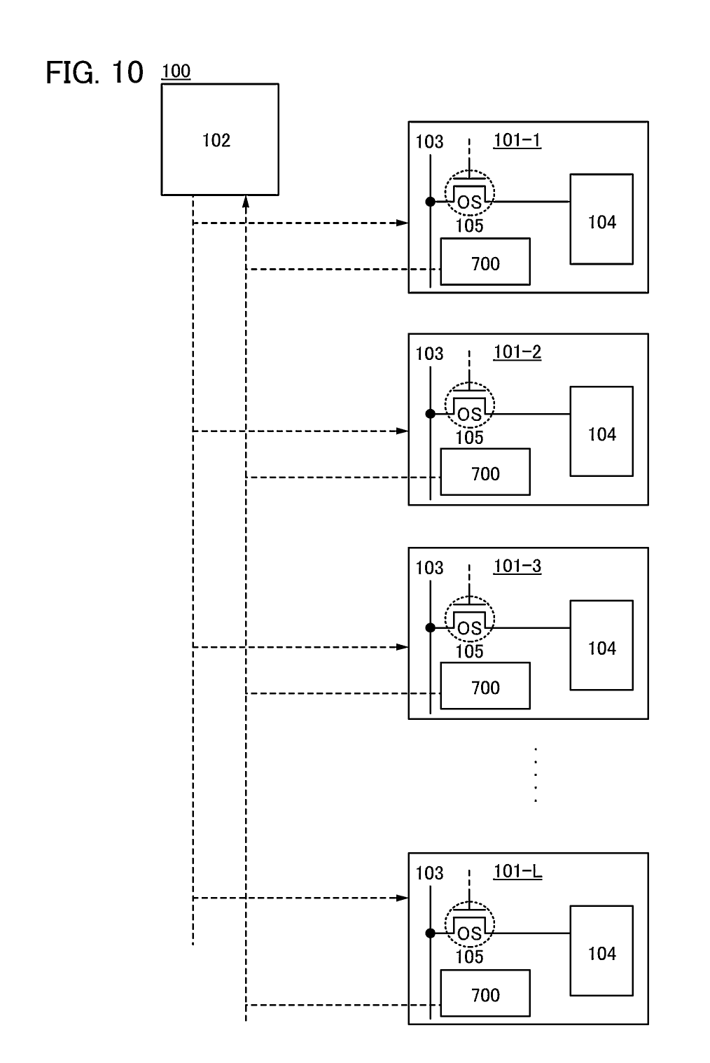

In the case where the components are provided independently, sensor circuits may be provided in the respective components and data obtained by the sensor circuits may be transmitted to the command unit 102 using wireless signals. A block diagram illustrating the case of providing a sensor circuit in each of the components, which is different from the case illustrated in FIG. 9, is illustrated in FIG. 10. As illustrated in FIG. 10, sensor circuits 700 are provided for the respective components and separately transmit data concerning physical values to the command unit 102. The command unit 102 monitors the physical values detected by the sensor circuits 700 provided in the respective components and judges the necessity of power supply to the loads 104.

Note that the components may be electrical appliances such as a computer, a detector, and a television; devices included in a computer system (a CPU, a memory, a HDD, a printer, a monitor); or electricity-controlled devices incorporated in a car. Alternatively, the components may be internal parts of an LSI such as a CPU or a semiconductor memory. Here, the computer refers to not only a tablet computer, a lap-top computer, and a desk-top computer, but also a large computer such as a server system.

The concept of the components can be applied to a wide ranging concept of social infrastructure, houses, and the like which require power supply systems, as well as electrical appliances that operate with supplied power.

Here, specific examples of the object to which the power supply system which is one embodiment of the present invention is applied in the case of application to a wide ranging concept of social infrastructure and the like are described. For example, in the case of applying the power supply system which is one embodiment of the present invention to social infrastructure, a railroad, a harbor, a road, and the like can be given as the components illustrated in FIG. 1, and a substation, a power plant, and the like can be given as the command unit. As another example, sections such as rooms or stories of a building can be given as the components illustrated in FIG. 1, and a power management facility, a switchboard, and the like can be given as the command unit.

### <Configuration of Power Supply System (2)>

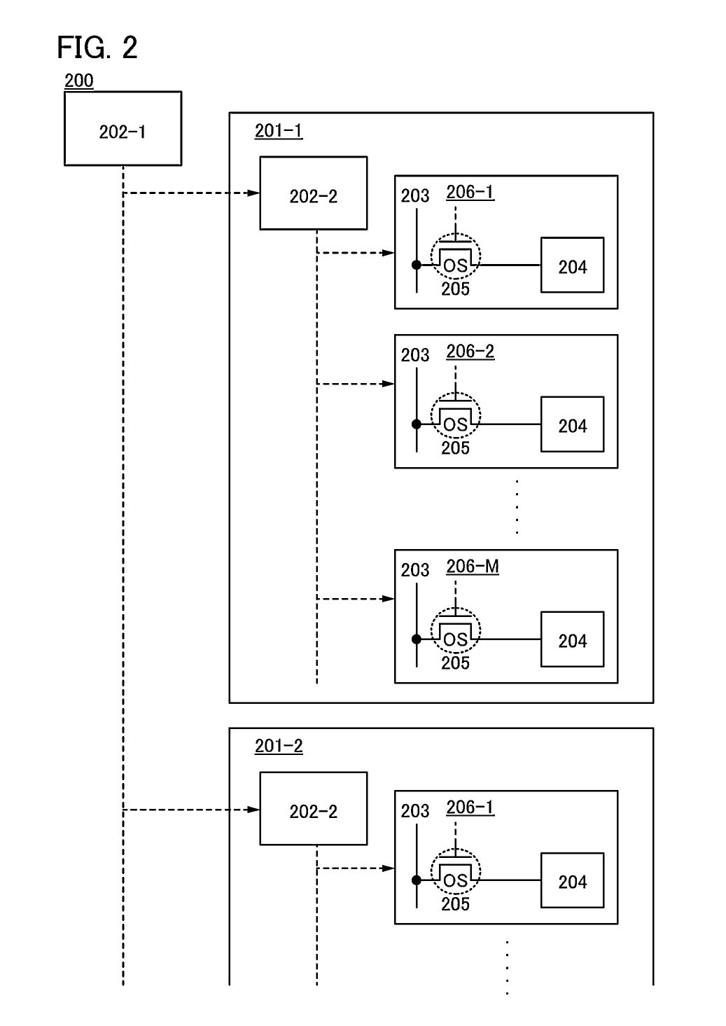

FIG. 2 illustrates another configuration of the power supply system of one embodiment of the present invention. A power supply system 200 illustrated in FIG. 2 includes first components 201-1 to 201-L (L is a natural number of 2 or more) and a first command unit 202-1 which separately controls power supply to the first components 201-1 to 201-L. FIG. 2 illustrates only the first component 201-1 and part of the first component 201-2.

In the power supply system 200, each of the first components 201-1 to 201-L includes a plurality of second components and a second command unit 202-2 which separately controls power supply to the plurality of second components. FIG. 2 specifically illustrates a case where the first component 201-1 includes second components 206-1 to 206-M (M is a natural number of 2 or more).

Note that the number of the plurality of second components included in the first component may vary among the first components 201-1 to 201-L.

As illustrated by the second components 206-1 to 206-M in FIG. 2, each of the plurality of second components includes a power supply line 203, a load 204 which consumes power, and a switch 205 which switches electrical connection between the power supply line 203 and the load 204. When the switch 205 is on, power is supplied from the power supply line 203 to the load 204 through the switch 205. When the switch 205 is off, power supply from the power supply line 203 to the load 204 is stopped.

The second components 206-1 to 206-M may share the power supply line 203. Alternatively, the power supply line 203 included in at least one second component among the second components 206-1 to 206-M may be different from the power supply line 203 included in the other second components. Alternatively, at least one of the plurality of second components included in one first component may share the power supply line 203 with at least one of the plurality of second components included in another first component.

In one embodiment of the present invention, a transistor including a semiconductor having a wider band gap than silicon in its channel formation region is used as the switch 205. The transistor has a significantly low off-state current compared with a transistor including silicon in its channel formation region. Accordingly, with one embodiment of the present invention where a transistor including a semiconductor having a wider band gap than silicon in its channel formation region is used as the switch 205, power supply from the power supply line 203 to the load 204 due to leak current flowing through the switch 205 when the switch 205 is off can be prevented.

Further in one embodiment of the present invention, due to the significantly low off-state current that flows through the switch 205, charge accumulated on the load 204 side can be held in a parasitic capacitor of the load 204. This enables rapid return operation when restarting power supply by turning on the switch 205.

Note that FIG. 2 illustrates an example in which the switch 205 is one transistor; however, the present invention is not limited to this configuration. In one embodiment of the present invention, the switch 205 may be a plurality of transistors.

The first command unit 202-1 judges the necessity of power supply to the loads 204 in the plurality of second components in each of the first components 201-1 to 201-L on a first component basis. The judgment may be made by a command input from the outside of the power supply system 200, or may be made based on monitored power consumption of the loads 204 or physical values detected by a sensor circuit, in a manner similar to the case of the command unit 102 of the power supply system 100 in FIG. 1.

Further, the second command unit 202-2 included in each of the first components 201-1 to 201-L judges the necessity of power supply to the loads 204 in the plurality of second components on a second component basis. The judgment may be made by a command input from the outside of the power supply system 200, or may be made based on monitored power consumption of the loads 204 or physical values detected by a sensor circuit, in a manner similar to the case of the command unit 102 of the power supply system 100 in FIG. 1.

The judgment on the necessity of power supply to the loads 204 by the second command unit 202-2 is made in the plurality of second components which are included in the first component which is judged by the first command unit 202-1 that power supply is necessary.

The second command unit 202-2 separately selects on or off of the switches 205 in the plurality of second components based on results of the judgment on the necessity of power supply.

Note that in the case where the load 204 included in one second component and the load 204 in another second component operate by interacting with each other, such a configuration as to conduct on/off control of the switches 205 all at once by the first command unit 202-1 or the second command unit 202-2 may be employed.

In the case where the second components are provided independently from one another, on/off selection of the switches by the first command unit 202-1 or the second command unit 202-2 is conducted using wireless signals. In this case, the switches preferably have a structure for holding a signal for changing the switch state from the first command unit 202-1 or the second command unit 202-2.

In the case where the second components are provided independently from one another, sensor circuits may be provided in the respective second components and data obtained by the sensor circuits may be transmitted to the first command unit 202-1 or the second command unit 202-2 using wireless signals.

### <Configuration of Power Supply System (3)>

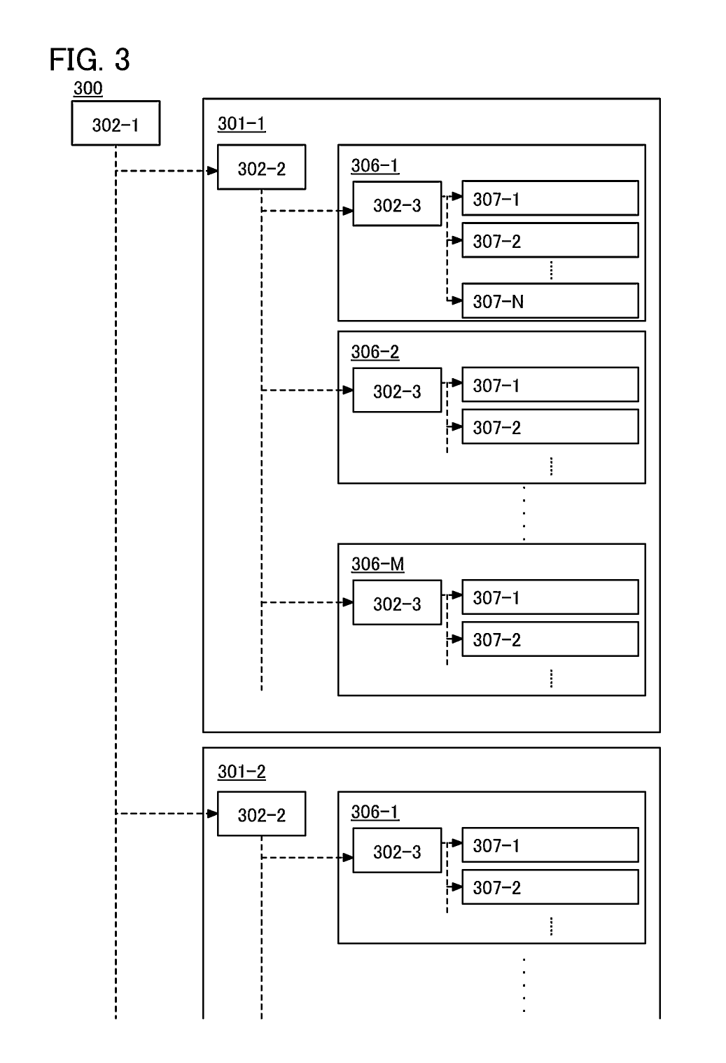

FIG. 3 illustrates another configuration of the power supply system of one embodiment of the present invention. A power supply system 300 illustrated in FIG. 3 includes first components 301-1 to 301-L and a first command unit 302-1 which separately controls power supply to the first components 301-1 to 301-L. FIG. 3 illustrates only the first component 301-1 and part of the first component 301-2.

In the power supply system 300, each of the first components 301-1 to 301-L includes a plurality of second components and a second command unit 302-2 which separately controls power supply to the plurality of second components. FIG. 3 specifically illustrates a case where the first component 301-1 includes second components 306-1 to 306-M.

Note that the number of the plurality of second components included in the first component may vary among the first components 301-1 to 301-L.

Further in the power supply system 300, each of the plurality of second components includes a plurality of third components and a third command unit 302-3 which separately controls power supply to the plurality of third components. FIG. 3 specifically illustrates a case where the second component 306-1 includes third components 307-1 to 307-N (N is a natural number of 2 or more).

Note that the number of the plurality of third components included in the second component may vary among the second components.

Although not illustrated in FIG. 3, each of the plurality of third components includes a power supply line, a load which consumes power, and a switch which switches electrical connection between the power supply line and the load, in a manner similar to those of the first components illustrated in FIG. 1 and the second components illustrated in FIG. 2. When the switch is on, power is supplied from the power supply line to the load through the switch. When the switch is off, power supply from the power supply line to the load is stopped.

The third components 307-1 to 307-N may share the power supply line. Alternatively, the power supply line included in at least one third component among the third components 307-1 to 307-N may be different from the power supply line included in the other third components. Alternatively, third components included in separate second components or third components included in separate first components may share the power supply line.

In one embodiment of the present invention, a transistor including in its channel formation region a semiconductor that has a wider band gap than silicon and is highly purified by reducing impurities such as moisture and hydrogen, which serve as electron donors (donors), and oxygen vacancies can be used as the switch. The transistor has a significantly low off-state current compared with a transistor including silicon in its channel formation region. Accordingly, with one embodiment of the present invention, power supply from the power supply line to the load due to leak current flowing through the switch when the switch is off can be prevented.

Further in one embodiment of the present invention, due to the significantly low off-state current that flows through the switch, charge accumulated on the load side can be held in a parasitic capacitor of the load. This enables rapid return operation when restarting power supply by turning on the switch.

The first command unit 302-1 judges the necessity of power supply to the loads in the plurality of third components in each of the first components 301-1 to 301-L on a first component basis. The judgment may be made by a command input from the outside of the power supply system 300, or may be made based on monitored power consumption of the loads or physical values detected by a sensor circuit, in a manner similar to the case of the command unit 102 of the power supply system 100 in FIG. 1.

Further, the second command unit 302-2 included in each of the first components 301-1 to 301-L judges the necessity of power supply to the loads in the plurality of third components on a second component basis. The judgment may be made by a command input from the outside of the power supply system 300, or may be made based on monitored power consumption of the loads or physical values detected by a sensor circuit, in a manner similar to the case of the command unit 102 of the power supply system 100 in FIG. 1.

The judgment on the necessity of power supply to the loads by the second command unit 302-2 is made in the plurality of second components which are included in the first component which is judged by the first command unit 302-1 that power supply is necessary.

Further, the third command unit 302-3 included in each of the second components 306-1 to 306-M judges the necessity of power supply to the loads in the plurality of third components on a third component basis. The judgment may be made by a command input from the outside of the power supply system 300, or may be made based on monitored power consumption of the loads or physical values detected by a sensor circuit, in a manner similar to the case of the command unit 102 of the power supply system 100 in FIG. 1.

The judgment on the necessity of power supply to the loads by the third command unit 302-3 is made in the plurality of third components which are included in the second component which is judged by the second command unit 302-2 that power supply is necessary.

The third command unit 302-3 separately selects on or off of the switches in the plurality of third components based on results of the judgment on the necessity of power supply.

Note that in the case where the load included in one third component and the load in another third component operate by interacting with each other, such a configuration as to conduct on/off control of the switches all at once by the first command unit 302-1, the second command unit 302-2, or the third command unit 302-3 may be employed.

In the case where the third components 307-1 to 307-N are provided independently from one another, on/off selection of the switches by the first command unit 302-1, the second command unit 302-2, or the third command unit 302-3 is conducted using wireless signals. In this case, the switches preferably have a structure for holding a signal for changing the switch state from the first command unit 302-1, the second command unit 302-2, or the third command unit 302-3.

In the case where the third components 307-1 to 307-N are provided independently from one another, a sensor circuit may be provided in each of the third components and data obtained by the sensor circuits may be transmitted to the first command unit 302-1, the second command unit 302-2, or the third command unit 302-3 using wireless signals.

### <Configuration of Power Supply System (4)>

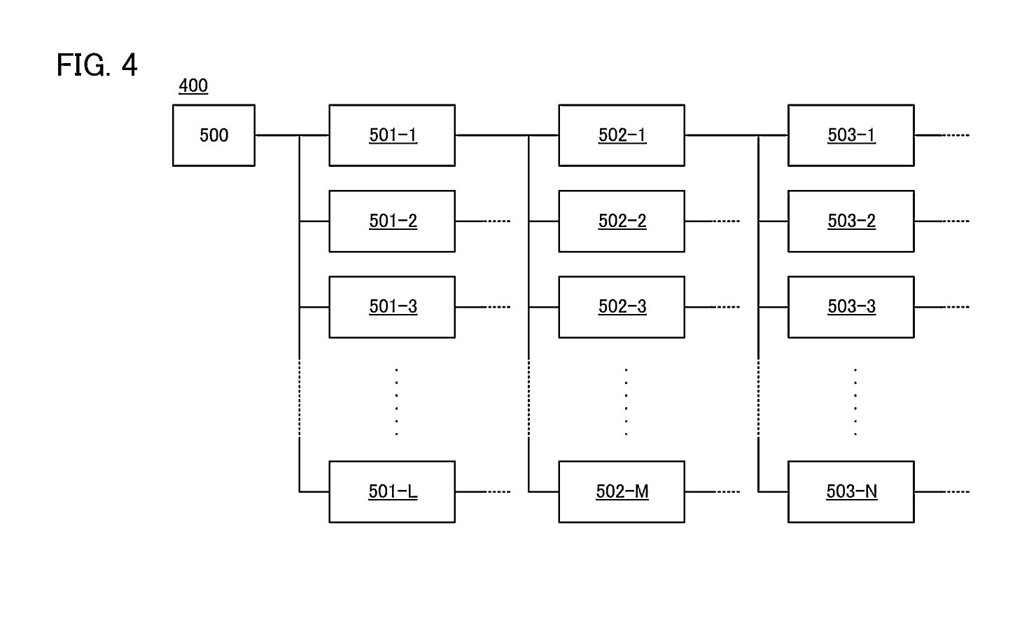

FIG. 4 illustrates another configuration of the power supply system of one embodiment of the present invention. A power supply system 400 illustrated in FIG. 4 includes a command unit 500, a plurality of first components, a plurality of second components, and a plurality of third components.

In the power supply system 400, although not illustrated in FIG. 4, each of the plurality of first components, the plurality of second components, and the plurality of third components includes a power supply line, a load which consumes power, and a switch which switches electrical connection between the power supply line and the load, in a manner similar to those of the first components illustrated in FIG. 1, the second components illustrated in FIG. 2, and the third components illustrated in FIG. 3. When the switch is on, power is supplied from the power supply line to the load through the switch. When the switch is off, power supply from the power supply line to the load is stopped.

In one embodiment of the present invention, as the switch, a transistor including in its channel formation region a semiconductor that has a wider band gap than silicon and is highly purified by reducing impurities such as moisture and hydrogen, which serve as electron donors (donors), and oxygen vacancies can be used. The transistor has a significantly low off-state current compared with a transistor including silicon in its channel formation region. Accordingly, with one embodiment of the present invention where a transistor including a semiconductor having a wider band gap than silicon in its channel formation region is used as the switch, power supply from the power supply line to the load due to leak current flowing through the switch when the switch is off can be prevented.

Further in one embodiment of the present invention, due to the significantly low off-state current that flows through the switch, charge accumulated on the load side can be held in a parasitic capacitor of the load. This enables rapid return operation when restarting power supply by turning on the switch.

In the power supply system 400, a power supply line included in each of any two or more of the plurality of second components is diverged from a power supply line included in one first component.

FIG. 4 specifically illustrates second components 502-1 to 502-M each including a power supply line diverged from a power supply line included in the first component 501-1 among the first components 501-1 to 501-L, and third components 503-1 to 503-N each including a power supply line diverged from the power supply line included in the second component 502-1.

Note that the number of the plurality of second components included in the first component may vary among the first components 501-1 to 501-L. In addition, the number of the plurality of third components included in the second component may vary among the second components.

In the power supply system 400, the command unit 500 judges the necessity of power supply to the loads in the plurality of first components, the plurality of second components, and the plurality of third components one by one. The judgment may be made by a command input from the outside of the power supply system 400, or may be made based on monitored power consumption of the loads or physical values detected by a sensor circuit, in a manner similar to the case of the command unit 102 of the power supply system 100 in FIG. 1.

Note that in the case where the load included in one of the first to third components and the load in another one of the first to third components operate by interacting with each other, such a configuration as to conduct on/off control of the switches all at once by the command unit 500 may be employed.

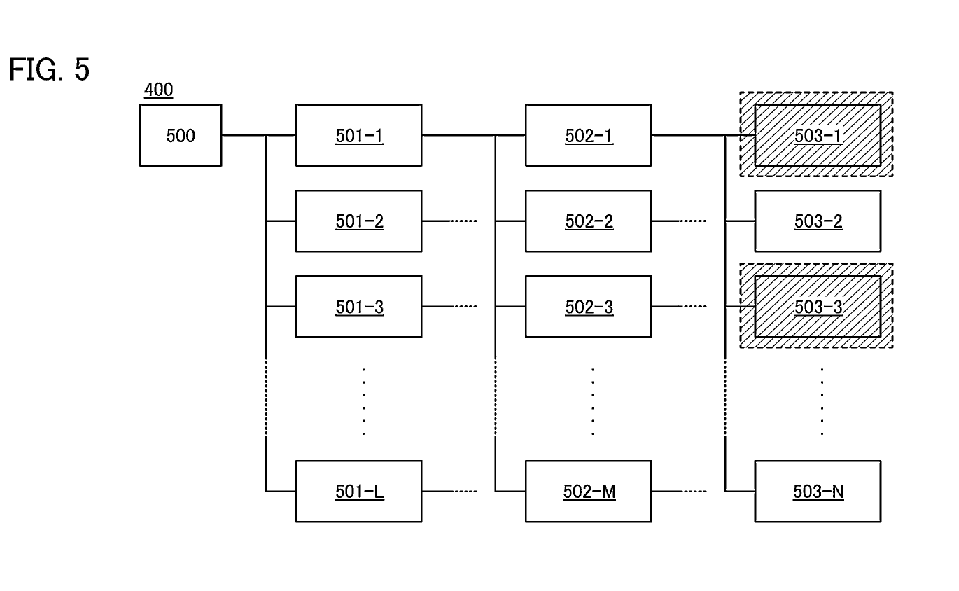

Next, an example of operation of the power supply system 400 is described. In FIG. 5, switches in the third component 503-1 and the third component 503-3 among all of the components are turned off at a command from the command unit 500 to stop power supply to the loads.

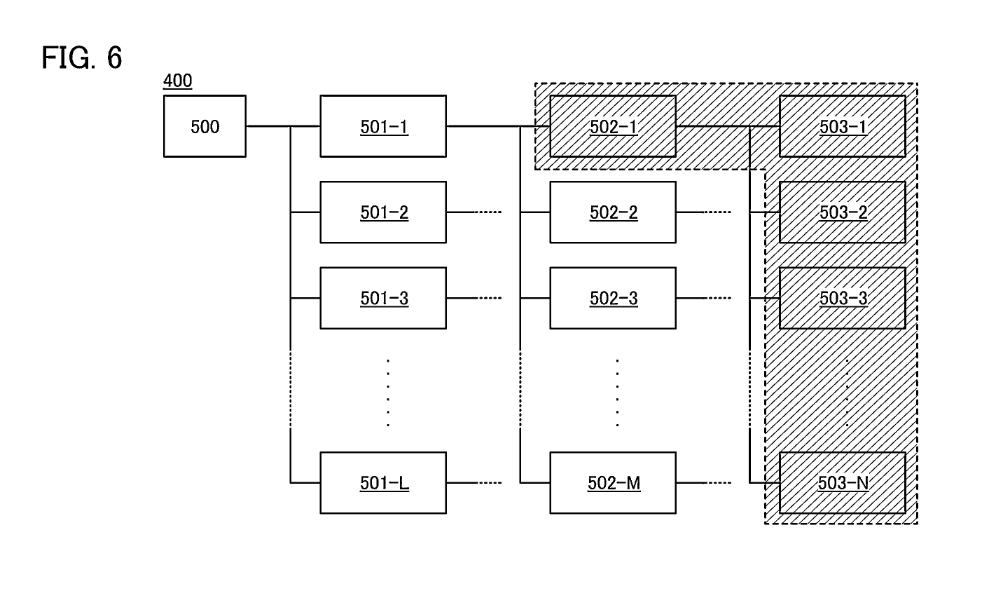

In FIG. 6, switches in the second component 502-1 and the third components 503-1 to 503-N each including the power supply line diverged from the power supply line included in the second component 502-1 among all of the components are turned off at a command from the command unit 500 to stop power supply to the loads.

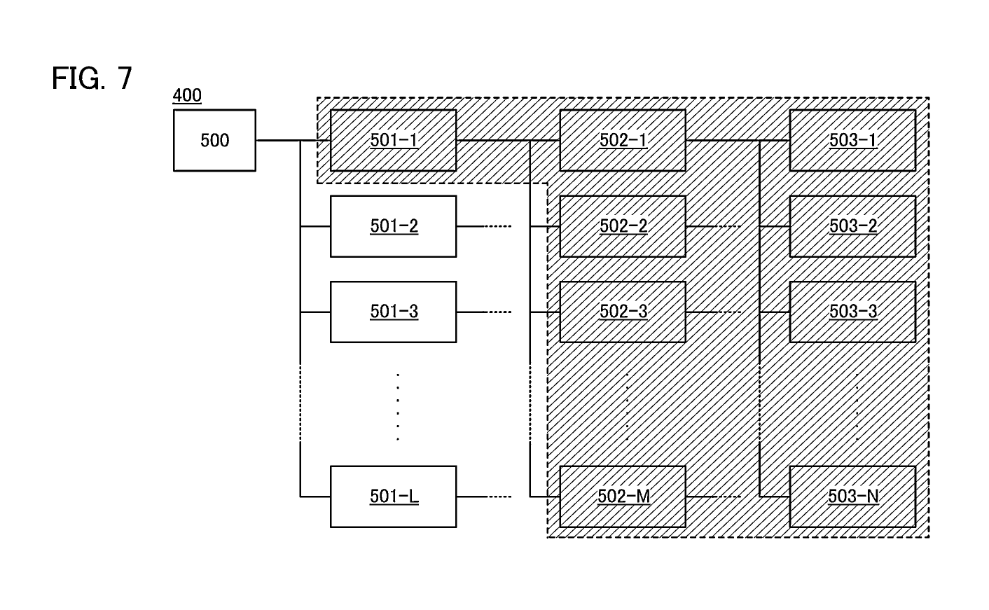

In FIG. 7, switches in the first component 501-1, the second components 502-1 to 502-M each including the power supply line diverged from the power supply line included in the first component 501-1, and the plurality of third components (including the third components 503-1 to 503-N) each including a power supply line diverged from the power supply line of any of the second components 502-1 to 502-M among all of the components are turned off at a command from the command unit 500 to stop power supply to the loads.

In the case where there is an independently-provided component, on/off selection of the switch in the component by the command unit 500 is conducted using wireless signals. In this case, the switch preferably has a structure for holding a signal for changing the switch state from the command unit 500.

In the case where there is an independently-provided component, a sensor circuit may be provided in the component and data obtained by the sensor circuit may be transmitted to the command unit 500 using wireless signals.

In the power supply systems of the embodiments of the present invention illustrated in FIG. 1, FIG. 2, FIG. 3, FIG. 4, FIG. 9, and FIG. 10, a transistor including in its channel formation region a semiconductor that has a wider band gap than silicon and is highly purified by reducing impurities such as moisture and hydrogen, which serve as electron donors (donors), and oxygen vacancies is used as the switch for switching electrical connection between the power supply line and the load in each component. However, in a component that needs to conduct switching between power supply to the load and stop of the power supply at high speed in the power supply system of one embodiment of the present invention, high-speed operation of the switch may take precedence over reduction of leak power from the switch. Specifically, in one embodiment of the present invention, in a component that needs to control switching of the switch at high speed, a transistor capable of high-speed switching such as a transistor including silicon having crystallinity in its channel formation region may be used as the switch. Further, in a component including a switch which needs to operate at high speed, a transistor including a germanium semiconductor, a gallium arsenide semiconductor, a Group 13-15 compound semiconductor, or the like in its channel formation region may be used as the switch.

### <Transistor Structure>

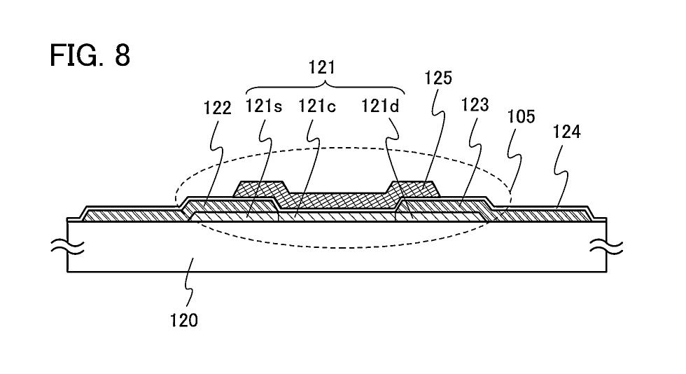

In one embodiment of the present invention, an oxide semiconductor is used for a channel formation region of the transistor serving as the switch 105. As described above, the oxide semiconductor included in the channel formation region allows an extremely low off-state current of the transistor. FIG. 8 illustrates an example of a cross-sectional view of the transistor.

The transistor in FIG. 8 includes, over a substrate 120 having an insulating surface, a semiconductor film 121 serving as an active layer, a source electrode 122 and a drain electrode 123 over the semiconductor film 121, a gate insulating film 124 over the semiconductor film 121, the source electrode 122, and the drain electrode 123, and a gate electrode 125 over the gate insulating film 124, which overlaps with the semiconductor film 121 between the source electrode 122 and the drain electrode 123.

In the transistor illustrated in FIG. 8, a region of the semiconductor film 121, which is between the source electrode 122 and the drain electrode 123 and overlaps with the gate electrode 125, corresponds to a channel formation region 121c. A region of the semiconductor film 121 which overlaps with the source electrode 122 corresponds to a source region 121s, and a region of the semiconductor film 121 which overlaps with a drain electrode 123 corresponds to a drain region 121d.

In one embodiment of the present invention, the oxide semiconductor only needs to be included in the channel formation region 121c of the semiconductor film 121; the oxide semiconductor may be included in the whole of the semiconductor film 121.

Although FIG. 8 illustrates the transistor with a single-gate structure, the transistor may have a multi-gate structure in which a plurality of electrically connected gate electrodes are provided so that a plurality of channel formation regions are included.

The transistor only needs to have a gate electrode on one side of the active layer; the transistor may include a pair of gate electrodes with the active layer interposed therebetween. In the case where the transistor includes a pair of gate electrodes with the active layer interposed therebetween, a signal for controlling switching (on/off) is applied to one of the gate electrodes, and the other of the gate electrodes may be in a floating state (i.e., electrically insulated) or applied with a potential. In the latter case, potentials with the same level may be applied to the pair of gate electrodes, or a fixed potential such as a ground potential may be applied only to the other of the gate electrodes. By controlling the level of a potential applied to the other of the gate electrodes, the threshold voltage of the transistor can be controlled.

Unless otherwise specified, in the case of an n-channel transistor, the off-state current in this specification is a current which flows between a source terminal and a drain terminal when, in the state where the potential of the drain terminal is greater than that of the source terminal and that of a gate electrode, the potential of the gate electrode is less than or equal to 0 V with respect to the potential of the source terminal. In the case of a p-channel transistor, the off-state current in this specification is a current which flows between a source terminal and a drain terminal when, in the state where the potential of the drain terminal is less than that of the source terminal and that of a gate electrode, the potential of the gate electrode is greater than or equal to 0 V with respect to the potential of the source terminal.

As one example of a semiconductor which has a wider band gap than a silicon semiconductor and has a lower intrinsic carrier density than silicon, a compound semiconductor such as gallium nitride (GaN) can be given in addition to an oxide semiconductor. The oxide semiconductor has an advantage of high mass productivity because transistors with excellent electrical characteristics can be formed by depositing the oxide semiconductor by a sputtering method or a wet process, unlike gallium nitride. Further, unlike gallium nitride, the oxide semiconductor can be deposited even at room temperature; thus, transistors with excellent electrical characteristics can be manufactured over a glass substrate or an integrated circuit using silicon. Further, a larger substrate can be used. Accordingly, among the semiconductors with wide band gaps, the oxide semiconductor particularly has an advantage of high mass productivity. Further, in the case where an oxide semiconductor with high crystallinity is to be obtained in order to improve the performance of a transistor (e.g., field-effect mobility), the oxide semiconductor with crystallinity can be easily obtained by heat treatment at 250° C. to 800° C.

A highly purified oxide semiconductor (purified OS) obtained by reduction of impurities such as moisture or hydrogen which serves as an electron donor (donor) and by reduction of oxygen vacancies is an intrinsic (i-type) semiconductor or a substantially i-type semiconductor. Therefore, a transistor including the oxide semiconductor has a characteristic of very small off-state current. Furthermore, the band gap of the oxide semiconductor is greater than or equal to 2 eV, preferably greater than or equal to 2.5 eV, and further preferably greater than or equal to 3 eV. With the use of the oxide semiconductor film which has been highly purified by sufficiently reducing the concentration of impurities such as moisture and hydrogen and reducing oxygen vacancies, the off-state current of the transistor can be reduced.

It can be proved through various experiments that the off-state current of the transistor using the highly purified oxide semiconductor film for a channel formation region is small. For example, even when an element has a channel width of 1×10⁶ μm and a channel length of 10 μm, off-state current can be less than or equal to the measurement limit of a semiconductor parameter analyzer, i.e., less than or equal to 1×10⁻¹³ A, at voltage (drain voltage) between the source electrode and the drain electrode of from 1 V to 10 V. In this case, it can be found that an off-state current normalized by the channel width of the transistor is less than or equal to 100 zA/μm. In addition, a capacitor and a transistor were connected to each other and the off-state current was measured by using a circuit in which electric charge flowing into or from the capacitor was controlled by the transistor. In the measurement, a highly purified oxide semiconductor film was used for a channel formation region of the transistor, and an off-state current of the transistor was measured from a change in the amount of electric charge of the capacitor per unit time. As a result, it was found that in the case where the voltage between the source electrode and the drain electrode of the transistor was 3V, a smaller off-state current of several tens yoctoampere per micrometer (yA/μm) was able to be obtained. Consequently, the transistor whose channel formation region is formed in a highly purified oxide semiconductor film has much smaller off-state current than a transistor including crystalline silicon.

An oxide semiconductor preferably contains at least indium (In) or zinc (Zn). The oxide semiconductor preferably contains, in addition to In and Zn, gallium (Ga) serving as a stabilizer that reduces variations in electrical characteristics of the transistor using the above-described oxide semiconductor. Tin (Sn) is preferably contained as a stabilizer. Hafnium (Hf) is preferably contained as a stabilizer. Aluminum (Al) is preferably contained as a stabilizer. Zirconium (Zr) is preferably contained as a stabilizer.

As another stabilizer, one or plural kinds of lanthanoid such as lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb), and lutetium (Lu) may be contained.

As the oxide semiconductor, for example, an indium oxide, a tin oxide, a zinc oxide, a two-component metal oxide such as an In—Zn-based oxide, a Sn—Zn-based oxide, an Al—Zn-based oxide, a Zn—Mg-based oxide, a Sn—Mg-based oxide, an In—Mg-based oxide, or an In—Ga-based oxide, a three-component metal oxide such as an In—Ga—Zn-based oxide (also referred to as IGZO), an In—Al—Zn-based oxide, an In—Sn—Zn-based oxide, a Sn—Ga—Zn-based oxide, an Al—Ga—Zn-based oxide, a Sn—Al—Zn-based oxide, an In—Hf—Zn-based oxide, an In—La—Zn-based oxide, an In—Pr—Zn-based oxide, an In—Nd—Zn-based oxide, an In—Sm—Zn-based oxide, an In—Eu—Zn-based oxide, an In—Gd—Zn-based oxide, an In—Tb—Zn-based oxide, an In—Dy—Zn-based oxide, an In—Ho—Zn-based oxide, an In—Er—Zn-based oxide, an In—Tm—Zn-based oxide, an In—Yb—Zn-based oxide, or an In—Lu—Zn-based oxide, a four-component metal oxide such as an In—Sn—Ga—Zn-based oxide, an In—Hf—Ga—Zn-based oxide, an In—Al—Ga—Zn-based oxide, an In—Sn—Al—Zn-based oxide, an In—Sn—Hf—Zn-based oxide, or an In—Hf—Al—Zn-based oxide can be used.

Note that, for example, an In—Ga—Zn-based oxide means an oxide containing In, Ga, and Zn, and there is no limitation on the ratio of In, Ga, and Zn. Further, the In—Ga—Zn-based oxide may contain a metal element other than In, Ga, and Zn. An In—Ga—Zn-based oxide has sufficiently high resistance when there is no electric field and thus the off-state current can be sufficiently reduced. In addition, the In—Ga—Zn-based oxide has high mobility.

For example, an In—Ga—Zn-based oxide with an atomic ratio of In:Ga:Zn=1:1:1 (=1/3:1/3:1/3) or In:Ga:Zn=2:2:1 (=2/5:2/5:1/5), or an oxide with an atomic ratio in the neighborhood of the above atomic ratios can be used. Alternatively, an In—Sn—Zn-based oxide with an atomic ratio of In:Sn:Zn=1:1:1 (=1/3:1/3:1/3), In:Sn:Zn=2:1:3 (=1/3:1/6:1/2), or In:Sn:Zn=2:1:5 (=1/4:1/8:5/8), or an oxide with an atomic ratio in the neighborhood of the above atomic ratios may be used.

For example, high mobility can be obtained relatively easily in the case of using an In—Sn—Zn-based oxide. However, mobility can be increased by reducing the defect density in a bulk also in the case of using an In—Ga—Zn-based oxide.

An oxide semiconductor film may be in a non-single-crystal state, for example. The non-single-crystal state is, for example, structured by at least one of c-axis aligned crystal (CAAC), polycrystal, microcrystal, and an amorphous part. The density of defect states of an amorphous part is higher than those of microcrystal and CAAC. The density of defect states of microcrystal is higher than that of CAAC. Note that an oxide semiconductor including CAAC is referred to as a CAAC-OS (c-axis aligned crystalline oxide semiconductor).

For example, an oxide semiconductor film may include a CAAC-OS. In the CAAC-OS, for example, c-axes are aligned, and a-axes and/or b-axes are not macroscopically aligned.

For example, an oxide semiconductor film may include microcrystal. Note that an oxide semiconductor including microcrystal is referred to as a microcrystalline oxide semiconductor. A microcrystalline oxide semiconductor film includes microcrystal (also referred to as nanocrystal) with a size greater than or equal to 1 nm and less than 10 nm, for example. Alternatively, a microcrystalline oxide semiconductor film, for example, includes a crystal-amorphous mixed phase structure where crystal parts (each of which is greater than or equal to 1 nm and less than 10 nm) are distributed.

For example, an oxide semiconductor film may include an amorphous part. Note that an oxide semiconductor including an amorphous part is referred to as an amorphous oxide semiconductor. An amorphous oxide semiconductor film, for example, has disordered atomic arrangement and no crystalline component. Alternatively, an amorphous oxide semiconductor film is, for example, absolutely amorphous and has no crystal part.

Note that an oxide semiconductor film may be a mixed film including any of a CAAC-OS, a microcrystalline oxide semiconductor, and an amorphous oxide semiconductor. The mixed film, for example, includes a region of an amorphous oxide semiconductor, a region of a microcrystalline oxide semiconductor, and a region of a CAAC-OS. Further, the mixed film may have a stacked structure including a region of an amorphous oxide semiconductor, a region of a microcrystalline oxide semiconductor, and a region of a CAAC-OS, for example.

Note that an oxide semiconductor film may be in a single-crystal state, for example.

An oxide semiconductor film preferably includes a plurality of crystal parts. In each of the crystal parts, a c-axis is preferably aligned in a direction parallel to a normal vector of a surface where the oxide semiconductor film is formed or a normal vector of a surface of the oxide semiconductor film. Note that, among crystal parts, the directions of the a-axis and the b-axis of one crystal part may be different from those of another crystal part. An example of such an oxide semiconductor film is a CAAC-OS film.

The CAAC-OS film is not absolutely amorphous. The CAAC-OS film, for example, includes an oxide semiconductor with a crystal-amorphous mixed phase structure where crystal parts and amorphous parts are intermingled. Note that in most cases, the crystal part fits inside a cube whose one side is less than 100 nm. In an image obtained with a transmission electron microscope (TEM), a boundary between an amorphous part and a crystal part and a boundary between crystal parts in the CAAC-OS film are not clearly detected. Further, with the TEM, a grain boundary in the CAAC-OS film is not clearly found. Thus, in the CAAC-OS film, a reduction in electron mobility due to the grain boundary is suppressed.

In each of the crystal parts included in the CAAC-OS film, for example, a c-axis is aligned in a direction parallel to a normal vector of a surface where the CAAC-OS film is formed or a normal vector of a surface of the CAAC-OS film. Further, in each of the crystal parts, metal atoms are arranged in a triangular or hexagonal configuration when seen from the direction perpendicular to the a-b plane, and metal atoms are arranged in a layered manner or metal atoms and oxygen atoms are arranged in a layered manner when seen from the direction perpendicular to the c-axis. Note that, among crystal parts, the directions of the a-axis and the b-axis of one crystal part may be different from those of another crystal part. In this specification, a term “perpendicular” includes a range from 80° to 100°, preferably from 85° to 95°. In addition, a term “parallel” includes a range from −10° to 10°, preferably from −5° to 5°.

In the CAAC-OS film, distribution of crystal parts is not necessarily uniform. For example, in the formation process of the CAAC-OS film, in the case where crystal growth occurs from a surface side of the oxide semiconductor film, the proportion of crystal parts in the vicinity of the surface of the oxide semiconductor film is higher than that in the vicinity of the surface where the oxide semiconductor film is formed in some cases. Further, when an impurity is added to the CAAC-OS film, the crystal part in a region to which the impurity is added becomes amorphous in some cases.

Since the c-axes of the crystal parts included in the CAAC-OS film are aligned in the direction parallel to a normal vector of a surface where the CAAC-OS film is formed or a normal vector of a surface of the CAAC-OS film, the directions of the c-axes may be different from each other depending on the shape of the CAAC-OS film (the cross-sectional shape of the surface where the CAAC-OS film is formed or the cross-sectional shape of the surface of the CAAC-OS film). Note that the film deposition is accompanied with the formation of the crystal parts or followed by the formation of the crystal parts through crystallization treatment such as heat treatment. Hence, the c-axes of the crystal parts are aligned in the direction parallel to a normal vector of the surface where the CAAC-OS film is formed or a normal vector of the surface of the CAAC-OS film.

In a transistor using the CAAC-OS film, change in electrical characteristics due to irradiation with visible light or ultraviolet light is small. Thus, the transistor has high reliability.

For example, the CAAC-OS film is formed by a sputtering method with a polycrystalline metal oxide target. When ions collide with the target, a crystal region included in the target may be separated from the target along an a-b plane; in other words, a sputtered particle having a plane parallel to the a-b plane (flat-plate-like sputtered particle or pellet-like sputtered particle) may flake off from the target. In that case, the flat-plate-like sputtered particle reaches a substrate in the state of maintaining their crystal state, whereby the CAAC-OS film can be formed.

For the deposition of the CAAC-OS film, the following conditions are preferably used.

By reducing the amount of impurities entering the CAAC-OS film during the deposition, the crystal state can be prevented from being broken by the impurities. For example, the concentration of impurities (e.g., hydrogen, water, carbon dioxide, or nitrogen) which exist in the deposition chamber may be reduced. Furthermore, the concentration of impurities in a deposition gas may be reduced. Specifically, a deposition gas whose dew point is lower than or equal to −80° C., preferably lower than or equal to −100° C. is used.

By increasing the substrate heating temperature during the deposition, migration of a sputtered particle is likely to occur after the sputtered particle reaches a substrate surface. Specifically, the substrate heating temperature during the deposition is higher than or equal to 100° C. and lower than or equal to 740° C., preferably higher than or equal to 200° C. and lower than or equal to 500° C. By increasing the substrate heating temperature during the deposition, when the flat-plate-like sputtered particle reaches the substrate, migration occurs on the substrate surface, so that a flat plane of the flat-plate-like sputtered particle is attached to the substrate.

Furthermore, it is preferable that the proportion of oxygen in the deposition gas be increased and the power be optimized in order to reduce plasma damage at the deposition. The proportion of oxygen in the deposition gas is higher than or equal to 30 vol %, preferably higher than or equal to 100 vol %.

As an example of the target, an In—Ga—Zn-based oxide target is described below.

The In—Ga—Zn-based oxide target, which is polycrystalline, is made by mixing InO_{X} powder, GaO_{Y} powder, and ZnO_{Z} powder in a predetermined molar ratio, applying pressure, and performing heat treatment at a temperature higher than or equal to 1000° C. and lower than or equal to 1500° C. Note that X, Y, and Z are each a given positive number. Here, the predetermined molar ratio of InO_{X} powder to GaO_{Y} powder and ZnO_{Z} powder is, for example, 2:2:1, 8:4:3, 3:1:1, 1:1:1, 4:2:3, or 3:1:2. The kinds of powder and the molar ratio for mixing powder may be determined as appropriate depending on the desired target.

This application is based on Japanese Patent Application serial no. 2012-056842 filed with Japan Patent Office on Mar. 14, 2012, the entire contents of which are hereby incorporated by reference.

What is claimed is:

1. A power supply system comprising:
a command unit; and
a plurality of components each comprising a power supply line, a load, and a switch,
wherein the command unit is operationally connected to the switch in each of the plurality of components,
wherein a first terminal of the switch is electrically connected to the load,
wherein a second terminal of the switch is electrically connected to the power supply line, and
wherein the switch is a transistor comprising a semiconductor having a wider band gap than silicon in a channel formation region.

2. The power supply system according to claim 1, wherein the command unit is electrically connected to a sensor circuit.

3. The power supply system according to claim 2, wherein the sensor circuit comprises at least one of an optical sensor, a pressure sensor, and a temperature sensor.

4. The power supply system according to claim 1, wherein the semiconductor is an oxide semiconductor.

5. The power supply system according to claim 1, wherein a band gap of the semiconductor is greater than or equal to 2 eV.

6. The power supply system according to claim 1, wherein the plurality of components comprise at least one of an electricity-controlled device incorporated in a car, a lighting device, an electric heater, an air cleaner, a computer, a detector, a television, a CPU, a memory, a HDD, a printer, and a monitor.

7. A power supply system comprising:
a first command unit;
a plurality of second command units; and
a plurality of components each comprising a power supply line, a load, and a switch,
wherein the first command unit is operationally connected to the plurality of second command units,
wherein one of the plurality of second command units is operationally connected to the switch in each of the plurality of components,
wherein a first terminal of the switch is electrically connected to the load,
wherein a second terminal of the switch is electrically connected to the power supply line, and
wherein the switch is a transistor comprising a semiconductor having a wider band gap than silicon in a channel formation region.

8. The power supply system according to claim 7, wherein the first command unit is electrically connected to a sensor circuit.

9. The power supply system according to claim 8, wherein the sensor circuit comprises at least one of an optical sensor, a pressure sensor, and a temperature sensor.

10. The power supply system according to claim 7, wherein the semiconductor is an oxide semiconductor.

11. The power supply system according to claim 7, wherein a band gap of the semiconductor is greater than or equal to 2 eV.

12. The power supply system according to claim 7, wherein the plurality of components comprise at least one of an electricity-controlled device incorporated in a car, a lighting device, an electric heater, an air cleaner, a computer, a detector, a television, a CPU, a memory, a HDD, a printer, and a monitor.

13. A power supply system comprising:
a command unit;
a plurality of first components each comprising a first power supply line, a first load, and a first switch;
a second component comprising a second power supply line diverged from the first power supply line, a second load, and a second switch; and
a third component comprising a third power supply line diverged from the second power supply line, a third load, and a third switch,
wherein a first terminal of the first switch is electrically connected to the first load,
wherein a second terminal of the first switch is electrically connected to the first power supply line,
wherein a first terminal of the second switch is electrically connected to the second load,
wherein a second terminal of the second switch is electrically connected to the second power supply line,
wherein a first terminal of the third switch is electrically connected to the third load,
wherein a second terminal of the third switch is electrically connected to the third power supply line,
wherein the command unit is operationally connected to the first switch in each of the plurality of first components, and
wherein each of the first switch, the second switch, and the third switch is a transistor comprising a semiconductor having a wider band gap than silicon in a channel formation region.

14. The power supply system according to claim 13, wherein the command unit is electrically connected to a sensor circuit.

15. The power supply system according to claim 14, wherein the sensor circuit comprises at least one of an optical sensor, a pressure sensor, and a temperature sensor.

16. The power supply system according to claim 13, wherein the semiconductor is an oxide semiconductor.

17. The power supply system according to claim 13, wherein a band gap of the semiconductor is greater than or equal to 2 eV.

18. The power supply system according to claim 13, wherein the plurality of first components comprise at least one of an electricity-controlled device incorporated in a car, a lighting device, an electric heater, an air cleaner, a computer, a detector, a television, a CPU, a memory, a HDD, a printer, and a monitor.
